(19) United States
(12) Patent Application Publication
(10) Pub. No.: US 2018/0026301 A1
(43) Pub. Date: Jan. 25, 2018

(54) ALL SOLID STATE BATTERY

(71) Applicant: TOYOTA JIDOSHA KABUSHIKI KAISHA, Toyota-shi (JP)

(72) Inventors: Hideyo EBISUZAKI, Toyota-shi (JP); Hideaki NISHIMURA, Hadano-shi (JP)

(21) Appl. No.: 15/621,556

(22) Filed: Jun. 13, 2017

(30) Foreign Application Priority Data
Jul. 22, 2016 (JP) 2016-144256

(51) Int. Cl. H01M 10/0562; H01M 4/587; H01C 7/02; H01M 4/505; H01M 4/58; H01M 4/38; H01M 4/62; H01M 4/525

(52) U.S. Cl. CPC H01M 10/0562; H01M 4/623; H01M 4/587; H01M 4/525; H01M 4/505; H01M 4/5825; H01M 4/386; H01M 4/387; H01C 7/02; H01M 2300/0071; H01M 2220/20; H01M 2200/106

(57) ABSTRACT

A main object of the present disclosure is to provide an all solid state battery in which the decrease of electron resistance due to the restraining pressure is inhibited. The present disclosure achieves the object by providing an all solid state battery comprising a laminated body provided with a cathode active material layer, a solid electrolyte layer, and an anode active material layer in this order, and a restraining member that applies a restraining pressure to the laminated body in a laminated direction, wherein a PTC layer containing a conductive material, an insulating inorganic substance, and a polymer, is provided in at least one of a position between the cathode active material layer and a cathode current collecting layer for collecting electrons of the cathode active material layer, and a position between the anode active material layer and an anode current collecting layer for collecting electrons of the anode active material layer, and the content of the insulating inorganic substance in the PTC layer is 50 volume % or more.

### TECHNICAL FIELD

The present disclosure relates to an all solid state battery.

### BACKGROUND ART

In accordance with a rapid spread of information relevant apparatuses and communication apparatuses such as a personal computer, a video camera and a portable telephone in recent years, the development of a battery to be used as a power source thereof has been emphasized. The development of a high-output and high-capacity battery for an electric automobile or a hybrid automobile has been advanced also in the automobile industry.

Conventionally, various technologies for improving safety such as technologies for preventing temperature rise during short circuits and misuses, and technologies for preventing short circuits, have been thought for the presently developed batteries.

For example, Patent Literature 1 discloses a nonaqueous secondary battery comprising a cathode, an anode, and a nonaqueous liquid electrolyte, wherein at least one of the cathode and the anode comprises a current collector, an electrode mixture, and a conductive layer that is formed between the current collector and the electrode mixture, and the conductive layer contains a conductive material and PVDF. The technology disclosed here is to increase the resistance by PVDF being expanded in volume when the temperature rises so as to cut the conducting path inside the conductive layer.

### CITATION LIST

### Patent Literature

Patent Literature 1: Japanese Patent Application Publication (JP-A) No. 2012-104422

### SUMMARY OF DISCLOSURE

### Technical Problem

In an all solid state battery to which the restraining pressure is applied in the laminated direction, the resistance to electrons of the conductive layer once increased could be decreased by a temperature rise in some cases. The present disclosure has been made in view of the above circumstances, and a main object thereof is to provide an all solid state battery in which the decrease of the resistance to electrons due to the restraining pressure is inhibited.

### Solution to Problem

In order to achieve the object, provided is an all solid state battery comprising a laminated body provided with a cathode active material layer, a solid electrolyte layer, and an anode active material layer in this order, and a restraining member that applies a restraining pressure to the laminated body in a laminated direction; wherein a PTC layer containing a conductive material, an insulating inorganic substance, and a polymer, is provided in at least one of a position between the cathode active material layer and a cathode current collecting layer for collecting electrons of the cathode active material layer, and a position between the anode active material layer and an anode current collecting layer for collecting electrons of the anode active material layer; and the content of the insulating inorganic substance in the PTC layer is 50 volume % or more.

According to the present disclosure, the content of the insulating inorganic substance in the PTC layer is 50 volume % or more so as to allow an all solid state battery in which the decrease of the resistance to electrons due to the restraining pressure is inhibited.

In the disclosure, the content of the insulating inorganic substance in the PTC layer may be 85 volume % or less.

In the disclosure, the insulating inorganic substance may be a metal oxide.

In the disclosure, the conductive material may be carbon black.

### Advantageous Effects of Disclosure

The present disclosure exhibits an effect such as to provide an all solid battery in which the decrease of the resistance to electrons due to the restraining pressure is inhibited.

### BRIEF DESCRIPTION OF DRAWING

FIG. 1 is a schematic cross-sectional view illustrating an example of the all solid state battery of the present disclosure.

### DESCRIPTION OF EMBODIMENTS

The all solid state battery of the present disclosure is hereinafter described in detail.

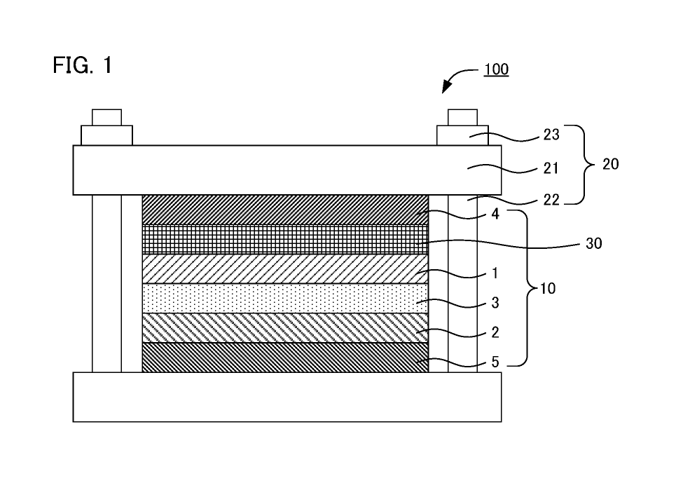

FIG. 1 is a schematic cross-sectional view illustrating an example of the all solid state battery of the present disclosure. All solid state battery 100 illustrated in FIG. 1 has laminated body 10 in which laminated are cathode active material layer 1, anode active material layer 2, solid electrolyte layer 3 formed between cathode active material layer 1 and anode active material layer 2, cathode current collecting layer 4 for collecting electrons of cathode active material layer 1, and anode current collecting layer 5 for collecting electrons of anode active material layer 2; restraining member 20 that applies a restraining pressure to laminated body 10; and PTC layer 30 between cathode active material layer 1 and cathode current collecting layer 4.

Restraining member 20 has two plate parts 21 that sandwich the upper and bottom surfaces of laminated body 10, pillar parts 22 that link the two plate parts 21, and controlling parts 23 that are connected to pillar parts 22 to control the restraining pressure by a structure such as a screw structure.

According to the present disclosure, the content of the insulating inorganic substance in the PTC layer is 50 volume % or more so as to allow an all solid state battery in which the decrease of the resistance to electrons due to the restraining pressure is inhibited.

Here, PTC is the abbreviation of “Positive Temperature Coefficient”, and the PTC layer refers to a layer provided with PTC properties that change the resistance to electrons to have a positive coefficient in accordance with the temperature rise.

In a conventional layer that contains a conductive material and a polymer, the polymer is expanded in volume by the temperature rise of the battery, and thereafter melted by the raised temperature, and the effect of the restraining pressure thereto brings the change in its form and the flow, which shortens the distance between the conductive materials that are lengthen by the polymer being expanded in volume; as the result, the cut conducting path is formed again to presumably decrease the resistance to electrons that has once increased.

In contrast, in the present disclosure, the decrease in the resistance to electrons is presumably inhibited such that the insulating inorganic substance included in the PTC layer inhibits the polymer melted by the temperature rise from changing in form and flowing due to the restraining pressure, and the lengthened distance between the conductive materials due to the polymer expanded in volume is maintained, which results in inhibiting the reformation of the cut conducting path.

Conventionally, PTC layers are used in the structure to which a restraining pressure is not applied such as the structure of a liquid battery. There has been no idea of intentionally increasing the content of the insulating layer in the PTC layer that would increase the resistance to electrons of the PTC layer in the occasion prior to the appearance of the PTC properties. However, the present disclosure focuses on the problem that the decrease in the resistance to electrons is caused only when the PTC layer is used in the structure to which a restraining pressure is applied such as the structure of an all solid state battery, and the aforementioned structure is adopted for the reason the effect to be obtained may surpass the slight increase in the resistance to electrons of the PTC layer in the occasion prior to the appearance of the PTC properties caused by inclusion of the insulating inorganic substance.

The all solid state battery is hereinafter described in each constitution.

1. PTC layer

The PTC layer is a layer provided in at least one of a position between the later described cathode active material layer and the later described cathode current collecting layer, and a position between the later described anode active material layer and the later described anode current collecting layer. Also, the PTC layer contains a conductive material, an insulating inorganic substance, and a polymer, and the content of the insulating inorganic substance in the PTC layer is 50 volume % or more.

The conductive material is not limited to any particular material if it has the desired electron conductivity, and examples thereof may include carbon materials. Examples of the carbon material may include carbon blacks such as furnace black, acetylene black, Ketjen black, and thermal black; carbon fibers such as carbon nanotube and carbon nanofiber; and activated carbon, carbon, graphite, graphene, and fullerene. Above all, it is preferable to use the carbon black. The reason therefor is that the carbon black has an advantage of high electron conductivity relative to the addition amount. The conductive material is not limited to any particular shape, and examples thereof may include a granular shape. The average primary particle size of the conductive material is, for example, preferably 10 nm or more and 200 nm or less, and more preferably 15 nm or more and 100 nm or less. Here, the average primary particle size of the conductive material may be, for example, calculated by measuring primary particle sizes of 30 pieces or more of conductive materials based on the image analysis using an electron microscope such as SEM (scanning electron microscope); an arithmetic mean of them may be adopted as the value for the average primary particle size.

The content of the conductive material in the PTC layer may be the amount that allows the resistance to electrons to increase during the temperature rise. For example, the content is preferably 50 volume % or less and more preferably 30 volume % or less. If the content of the conductive material is large, the distance between the conductive materials may not be lengthened due to the volume expansion of the polymer, and thus the increase in the resistance to electrons may be insufficient. Also, the content of the conductive material in the PTC layer may be the amount with which stable electron conductivity is secured during the normal use. For example, the content is preferably 5 volume % or more, more preferably 10 volume % or more, and further preferably 20 volume % or more. If the content of the conductive material is small, the number of the conducting path to be formed may decrease and thus the electron conductivity of the PTC layer may decrease.

For example, the addition amount of the conductive material, if carbon black is used, is preferably 8 volume % or more and 50 volume % or less and more preferably 10 volume % or more and 30 volume % or less.

The insulating inorganic substance is not limited if the substance has insulating properties and the melting point thereof is higher than the melting point of the later described polymer. Examples thereof may include a metal oxide and a metal nitride. Examples of the metal oxide may include alumina, zirconia, and silica, and examples of the metal nitride may include silicon nitride. Additional example of the insulating inorganic substance may be ceramic materials. Also, the insulating inorganic substance is not limited to any particular shape, and examples thereof may include a granular shape. If the insulating inorganic substance is in a granular shape, the insulating inorganic substance may be a primary particle and may be a secondary particle. The average particle size (D50) of the insulating inorganic substance is, for example, preferably 50 nm or more and 5 μm or less and more preferably 100 nm or more and 2 μm or less.

The content of the insulating inorganic substance in the PTC layer may be the amount with which the change in form and the flow of the polymer melted during the temperature rise is inhibited; typically, the content is preferably 50 volume % or more and more preferably 60 volume % or more. If the content of the insulating inorganic substance is small, the change in form and the flow of the polymer melted during the temperature rise may not be inhibited sufficiently. Also, the content of the insulating inorganic substance in the PTC layer may be the amount with which stable electron conductivity is secured during the normal use. For example, the content is preferably 85 volume % or less and more preferably 80 volume % or less. If the content of the insulating inorganic substance is too large, the content of the polymer relatively decreases, and the distance between the conductive materials may not be lengthened due to the polymer expanded in volume, and thus the increase in the resistance to electrons may be insufficient. Also, the conducting path to be formed by the conductive material would be interfered by the insulating inorganic substance and thus the electron conductivity of the PTC layer may decrease.

The polymer is not limited if it may be expanded in volume during the temperature rise, and examples thereof may include thermoplastic resins. Examples of the thermoplastic resin may include polyvinylidene fluoride (PVDF), polypropylene, polyethylene, polyvinyl chloride, polystyrene, an acrylonitrile-butadiene-styrene (ABS) resin, a methacrylic resin, polyamide, polyester, polycarbonate, and polyacetal.

The melting point of the polymer may be the temperature higher than the temperature during the normal use of the battery. For example, the melting point is preferably 80° C. or more and 300° C. or less, and more preferably 100° C. or more and 250° C. or less. The melting point may be, for example, measured by a differential thermal analysis (DTA).

The content of the polymer in the PTC layer may be the amount that allows the increase in the resistance to electrons by the volume expansion during the temperature rise. The content is, for example, preferably 5 volume % or more and more preferably 10 volume % or more. If the content of the polymer is small, the distance between the conductive materials may not be lengthened due to the polymer expanded in volume, and thus the increase in the resistance to electrons may be insufficient. Also, the content of the polymer in the PTC layer may be the amount with which stable electron conductivity may be secured during the normal use of the battery. For example, the content is preferably 90 volume % or less and more preferably 80 volume % or less. If the content of the polymer is large, the conducting path to be formed by the conductive material would be interfered by the polymer and thus the electron conductivity of the PTC layer may decrease.

Also, when the volume of the PTC layer is regarded as X and the volume of the polymer included in the PTC layer is regarded as Y, it is preferable that (X−Y)/Y is 1.5 or more. The content ratio of the polymer in the PTC layer being in the range may inhibit the shape change and the flow of the polymer melted during the temperature rise.

The thickness of the PTC layer is, for example, preferably 1 μm or more and 20 μm or less, and more preferably 1 μm or more and 10 μm or less.

The method for producing the PTC layer is not limited to any particular method if the method allows the above described PTC layer to be obtained. Examples thereof may include a method of forming the PTC layer by mixing the above described conductive material, insulating inorganic substance, and polymer with an organic solvent such as N-methylpyrrolidone to form the paste, coating the current collecting layer with the paste, and drying the paste.

2. Cathode Active Material Layer

The cathode active material layer is a layer containing at least a cathode active material. Also, the cathode active material layer may further contain at least one of a solid electrolyte material, a conductive material, and a binder other than the cathode active material.

As the cathode active material, cathode active materials applicable to all solid state batteries may be appropriately used. Examples of such a cathode active material may include rock salt bed type active materials such as lithium cobalt oxide (LiCoO₂), lithium nickel oxide (LiNiO₂), and LiNi_{1/3}Co_{1/3}Mn_{1/3}O₂, spinel type active materials such as lithium manganese oxide (LiMn₂O₄) and Li(Ni_{0.5}Mn_{1.5})O₄, lithium titanium oxide (Li₄Ti₅O₁₂), and olivine type active materials such as LiFePO₄, LiMnPO₄, LiCoPO₄, and LiNiPO₄. The shape of the cathode active material may be, for example, a granular shape and a thin film shape. If the cathode active material is in a granular shape, the cathode active material may be a primary particle and may be a secondary particle. Also, the average particle size (D50) of the cathode active material is, for example, preferably 1 nm or more and 100 μm or less, and more preferably 10 nm or more and 30 μm or less.

The solid electrolyte material is not limited to any particular material if the material has ion conductivity, and examples thereof may include inorganic solid electrolyte materials such as sulfide solid electrolyte materials and oxide solid electrolyte materials. Examples of the sulfide solid electrolyte material may include Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—P₂S₅, and Li₃PS₄. Above all, it is preferable to use the sulfide solid electrolyte material. The sulfide solid electrolyte material could generate hydrogen sulfide due to the temperature rise although it has high ion conductivity. Accordingly, increasing the resistance to electrons using the PTC layer to effectively inhibit the temperature rise may result in inhibiting the generation of hydrogen sulfide and allowing the battery to have high ion conductivity.

As the conductive material, the same materials as those described in “1. PTC layer” above may be used. Meanwhile, the binder is not limited to any particular material if it is chemically and electronically stable. Examples thereof may include fluorine based binders such as polyvinylidene fluoride (PVDF) and polytetra fluoroethylene (PTFE).

Also, the content of the cathode active material in the cathode active material layer is preferably larger from the viewpoint of the capacity. For example, the content is 30 mass % or more, preferably 50 mass % or more, and more preferably 70 mass % or more. Also, the thickness of the cathode active material layer is, for example, preferably 0.1 μm or more and 1000 μm or less.

3. Anode Active Material Layer

The anode active material layer is a layer containing at least an anode active material. Also, the anode active material layer may further contain at least one of a solid electrolyte material, a conductive material, and a binder other than the anode active material.

As the anode active material, known anode active materials capable of absorbing and releasing metal ions may be appropriately used. Examples of such an anode active material may include metal active materials and carbon active materials. Examples of the metal active material may include In, Al, Si, and Sn. On the other hand, examples of the carbon active material may include mesocarbon microbeads (MCMB), highly oriented pyrolytic graphite (HOPG), hard carbon, and soft carbon. The anode active material may be in a shape such as a granular shape and a thin film shape. If the anode active material is in a granular shape, the anode active material may be a primary particle and may be a secondary particle. Also, the average particle size (D50) of the anode active material is, for example, preferably 1 nm or more and 100 μm or less, and more preferably 10 nm or more and 30 μm or less.

Regarding the solid electrolyte material, the conductive material and the binder, the same materials as those described in “1. PTC layer” and “2. Cathode active material layer” above may be used. Also, the content of the anode active material in the anode active material layer is preferably larger from the viewpoint of the capacity. For example, the content is 30 mass % or more, preferably 50 mass % or more, and more preferably 70 mass % or more. Also, the thickness of the anode active material layer is, for example, preferably 0.1 μm or more and 1000 μm or less.

4. Solid Electrolyte Layer

The solid electrolyte layer is a layer to be formed between the cathode active material layer and the anode active material layer. The solid electrolyte material to be used for the solid electrolyte layer may be the same materials described in “2. Cathode active material layer” above.

Also, the solid electrolyte layer may contain only the solid electrolyte material, and may further contain additional material. Examples of the additional material may include a binder. The contents regarding the binder are the same as those described in “2. Cathode active material layer” above. The thickness of the solid electrolyte layer is, for example, preferably 0.1 μm or more and 1000 μm or less.

5. Current Collecting Layer

For the cathode current collecting layer and the anode current collecting layer, known metals usable as current collectors in an all solid state battery may be used. Examples of such a metal may include metal materials that contain one or two elements or more of Cu, Ni, Al, V, Au, Pt, Mg, Fe, Ti, Co, Cr, Zn, Ge, and In. The cathode current collecting layer and the anode current collecting layer are not limited to any particular shape. Examples of the shape may include a foil shape, a mesh shape, and a porous shape.

6. Restraining Member

The restraining member may be known restraining members usable as a restraining member in an all solid state battery and capable of applying a restraining pressure to the laminated body provided with a cathode active material layer, a solid electrolyte layer, and an anode active material layer, in the laminated direction. Examples of the restraining member may include the restraining member that has two plate parts to sandwich the upper and bottom surfaces of the laminated body, pillar parts to link the two plate parts, and controlling parts connected to the pillar parts to control the restraining pressure by a structure such as a screw structure. The desired restraining pressure may be applied to the laminated body by the controlling parts.

The restraining pressure is not limited to any particular pressure. For example, the pressure is preferably 0.1 MPa or more, more preferably 1 MPa or more, and further preferably 5 MPa or more. There is an advantage that the contact between each layer may be easily improved by increasing the restraining pressure. Meanwhile, the restraining pressure is, for example, preferably 100 MPa or less, more preferably 50 MPa or less, and further preferably 20 MPa or less. Too large a restraining pressure requires high rigidity of the restraining member, and could cause increase in size of the restraining member.

7. All Solid State Battery

The all solid state battery may be a primary battery and may be a secondary battery, but preferably a secondary battery among them. The reason therefor is to repeatedly charge and discharge and be useful as a car mounted battery for example. Also, examples of the shape of the all solid state battery may include a coin shape, a laminate shape, a cylindrical shape, and a square shape.

Incidentally, the present disclosure is not limited to the embodiments. The embodiments are exemplification, and other variations are intended to be included in the technical scope of the present disclosure if they have substantially the same constitution as the technical idea described in the claim of the present disclosure and offer similar operation and effect thereto.

### EXAMPLES

The present disclosure is hereinafter described in more details with reference to Examples.

### Example 1

Prepared were furnace black with the average primary particle size of 66 nm (from TOKAI CARBON CO., LTD.) as a conductive material, alumina (CB-P02 from SHOWA DENKO K.K) as an insulating inorganic substance, and PVDF (KF polymer L*9130 from KUREHA CORPORATION) as a polymer, which were mixed with a solvent N-methylpyrrolidone to have the volume ratio of furnace black:alumina:PVDF=10:50:40 and thereby a paste was prepared. After that, a 15 μm thick aluminum foil was coated with the paste so as the thickness of the coated foil after drying thereof became 10 μm, dried in the conditions of 100° C. in a stational drying furnace for 1 hour, and thereby an aluminum foil provided with a PTC layer was formed.

### Example 2

An aluminum foil provided with a PTC layer was formed in the same manner as in Example 1, replacing the volume ratio to be furnace black:alumina:PVDF=10:60:30.

### Example 3

An aluminum foil provided with a PTC layer was formed in the same manner as in Example 1, replacing the volume ratio to be furnace black:alumina:PVDF=10:80:10.

### Example 4

An aluminum foil provided with a PTC layer was formed in the same manner as in Example 1, replacing the volume ratio to be furnace black:alumina:PVDF=10:85:5.

### Example 5

An aluminum foil provided with a PTC layer was formed in the same manner as in Example 1, replacing the volume ratio to be furnace black:alumina:PVDF=10:88:2.

### Comparative Example 1

An aluminum foil provided with a PTC layer was formed in the same manner as in Example 1, replacing the volume ratio to be furnace black:alumina:PVDF=10:0:90.

### Comparative Example 2

An aluminum foil provided with a PTC layer was formed in the same manner as in Example 1, replacing the volume ratio to be furnace black:alumina:PVDF=10:10:80.

### Comparative Example 3

An aluminum foil provided with a PTC layer was formed in the same manner as in Example 1, replacing the volume ratio to be furnace black:alumina:PVDF=10:20:70.

### Comparative Example 4

An aluminum foil provided with a PTC layer was formed in the same manner as in Example 1, replacing the volume ratio to be furnace black:alumina:PVDF=10:30:60.

### Comparative Example 5

An aluminum foil provided with a PTC layer was formed in the same manner as in Example 1, replacing the volume ratio to be furnace black:alumina:PVDF=10:40:50.

[Evaluation]

(Measurement of Resistance to Electrons)

The measurement of resistance to electrons was conducted for the aluminum foil provided with the PTC layer obtained in Examples 1 to 5 and Comparative Examples 1 to 5, respectively before, during, and after heating. Specifically, the produced aluminum foil provided with the PTC layer was punched into a circle shape with the diameter of 11.28 cm, pinched with cylindrical terminals of the same diameter, and the restraining pressure of 10 MPa was applied to between the terminals and thereby the resistance to electrons before heating was measured. Constant current of 1 mA was conducted to between the terminals to measure the resistance to electrons, and the value of the resistance to electrons was calculated by measuring the voltage between the terminals. Regarding the measurement of the resistance to electrons during heating, the aluminum foil provided with the PTC layer pinched with the terminals was disposed in a thermostatic oven, heated to 200° C., the temperature was maintained for 1 hour, and the resistance to electrons was measured by the aforementioned method. The maximum value of the resistance to electrons measured during heating was determined as the resistance to electrons during heating. After the completion of heating, the resistance to electrons after heating was measured by the aforementioned method.

Here, evaluated was whether the decrease in the resistance to electrons after heating was seen or not. The decrease was determined such that if the rate of the resistance to electrons after heating became 0.9 or less with respect to the resistance to electrons during heating, the decrease in the resistance to electrons was seen (•), and if the rate became more than 0.9, the decrease in the resistance to electrons was not seen (◯). In addition, evaluated was whether the increase in the resistance to electrons during heating was seen or not, for an example of the parameter of the PTC properties. The increase was determined such that if the rate of the resistance to electrons during heating, which was in the conditions of heating at 200° C. and maintaining the temperature for 1 hour, became 2 or more with respect to the resistance to electrons before heating, the PTC properties were excellent (⊙), and if the rate became 1.5 or more and less than 2, the PTC properties were good (◯). The results are shown in Table 1.

TABLE 1

| | Content [Volume %] | | | | |
|---|---|---|---|---|---|
| | | Insulating | | Decrease in | |
| | Conductive | inorganic | | resistance to | PTC |
| | material | substance | Polymer | electrons | properties |
| Comparative Example 1 | 10 | 0 | 90 | X | ⊚ |
| Comparative Example 2 | 10 | 10 | 80 | X | ⊚ |
| Comparative Example 3 | 10 | 20 | 70 | X | ⊚ |
| Comparative Example 4 | 10 | 30 | 60 | X | ⊚ |
| Comparative Example 5 | 10 | 40 | 50 | X | ⊚ |
| Example 1 | 10 | 50 | 40 | ◯ | ⊚ |
| Example 2 | 10 | 60 | 30 | ◯ | ⊚ |
| Example 3 | 10 | 80 | 10 | ◯ | ⊚ |
| Example 4 | 10 | 85 | 5 | ◯ | ⊚ |
| Example 5 | 10 | 88 | 2 | ◯ | ◯ |

As shown in Table 1, the decrease in the resistance to electrons of the PTC layer by the effect of the restraining pressure could not be inhibited in Comparative Examples 1 to 5. The reason therefor was presumably because the amount of the insulating inorganic substance included in the PTC layer was small so that the melted polymer was changed in form and flown due to the restraining pressure, which resulted in shortening the distance between the conductive materials.

In contrast, the decrease in the resistance to electrons of the PTC layer by the effect of the restraining pressure was inhibited in Examples 1 to 5. The reason therefor was presumably because the insulating inorganic substance included in the PTC layer in the proportion of 50 volume % or more received the restraining pressure and thereby the change in form and the flow of the melted polymer was inhibited, which resulted in inhibiting shortening the distance between the conductive materials.

In this manner, it was confirmed that the decrease in the resistance to electrons due to the effect of the restraining pressure was inhibited when the content of the insulating inorganic substance in the PTC layer was 50 volume % or more.

On the other hand, the resistance to electrons during heating was increased in Examples 1 to 4, and the exhibition of the excellent PTC properties was confirmed. In contrast, it was confirmed that the increase in the resistance to electrons during heating was small in Example 5. The reason therefor was presumably because the amount of the polymer included in the PTC layer was 2 volume % which was small and thereby lengthening the distance between the conductive materials was insufficient due to the polymer expanded in volume.

### REFERENCE SIGNS LIST

1 . . . cathode active material layer
2 . . . anode active material layer
3 . . . solid electrolyte layer
4 . . . cathode current collecting layer
5 . . . anode current collecting layer
10 . . . laminated body
20 . . . restraining member
21 . . . plate part
22 . . . pillar part
23 . . . controlling part
30 . . . PTC layer
100 . . . all solid state battery

What is claimed is:

1. An all solid state battery comprising a laminated body provided with a cathode active material layer, a solid electrolyte layer, and an anode active material layer in this order, and a restraining member that applies a restraining pressure to the laminated body in a laminated direction, wherein
a PTC layer containing a conductive material, an insulating inorganic substance, and a polymer, is provided in at least one of a position between the cathode active material layer and a cathode current collecting layer for collecting electrons of the cathode active material layer, and a position between the anode active material layer and an anode current collecting layer for collecting electrons of the anode active material layer, and
the content of the insulating inorganic substance in the PTC layer is 50 volume % or more.

2. The all solid state battery according to claim 1, wherein the content of the insulating inorganic substance in the PTC layer is 85 volume % or less.

3. The all solid state battery according to claim 1, wherein the insulating inorganic substance is a metal oxide.

4. The all solid state battery according to claim 1, wherein the conductive material is carbon black.
